(19) United States
(12) Patent Application Publication
(10) Pub. No.: US 2021/0216943 A1
(43) Pub. Date: Jul. 15, 2021

(54) SALESPERSON EVALUATION SYSTEM, SALESPERSON EVALUATION APPARATUS, SALESPERSON EVALUATION METHOD, AND SALESPERSON EVALUATION PROGRAM

(71) Applicant: VANISH STANDARD CO., LTD., Tokyo (JP)

(72) Inventor: Yasuaki ONOZATO, Tokyo (JP)

(21) Appl. No.: 16/755,016

(22) PCT Filed: Sep. 5, 2019
(86) PCT No.: PCT/JP2019/035002

§ 371 Date: Aug. 13, 2020

(51) Int. Cl. G06Q 10/06

(52) U.S. Cl. CPC G06Q 10/06398

(57) ABSTRACT

There are provided an index value calculation unit 22 that calculates a predetermined sales tendency index value relevant to sales tendency of each of a plurality of sales target products based on the sales status data of the sales target products, a sluggish sales product setting unit 33 that sets a sales target product, for which the calculated sales tendency index value satisfies predetermined conditions, as a sluggish sales product, and a point giving unit 36 that gives a point to a salesperson who sells the sluggish sales product. By motivating a salesperson to sell a sluggish sales product, it is possible to increase sales figure through an increase in the sales volume of the sluggish sales product. At the same time, it is possible to reduce costs that may increase due to inventory management, return processing, disposal, and the like.

### TECHNICAL FIELD

The present invention relates to a salesperson evaluation system, a salesperson evaluation apparatus, a salesperson evaluation method, and a salesperson evaluation program, and is particularly suitable for use in a system for evaluating, based on sales performance, a salesperson who sells products.

### BACKGROUND ART

In the related art, there has been known a system that gives an incentive, such as a point or a bonus, to a salesperson who sells products, based on sales performance or the like, in order to increase motivation for sales (for example, refer to Patent Documents 1 to 3).

In the system described in Patent Document 1, a sales support server gives a point corresponding to the sales performance of a salesperson according to a predetermined point grant rule, and provides commemorative goods as rewards according to the number of points earned.

In the system described in Patent Document 2, a plurality of periods are set, a product to which focus is to be given for sale during the period among products handled is designated as a target product for each period, and the sales target number of target products is set for a salesperson in each store. Then, a predetermined number of points are given to the salesperson in accordance with the sales target achievement rate each time the period passes, and after the end of a series of point grant target periods, a predetermined premium is given according to the total number of points earned by the salesperson.

In the system described in Patent Document 3, an incentive (reward) is given to a salesperson who triggers a user to purchase a product using an EC site. For example, a salesperson code associated with the product code of a recommended product (product selected by a product manager) is read from an order information storage unit, and an incentive (a predetermined percentage of the amount of order of the recommended product, a predetermined amount corresponding to the number of recommended products ordered, or the like) is given to a salesperson corresponding to the salesperson code. Patent Document 3 also discloses an example in which an incentive is given for sales of normal products.
Patent Document 1: JP-A-2003-6422
Patent Document 2: JP-A-2001-22821
Patent Document 3: JP-A-2014-182760

### SUMMARY OF THE INVENTION

### Technical Problem

As described in Patent Documents 1 to 3, the purpose of giving incentives to salespersons according to the sales performance is to motivate each salesperson to increase sales of the entire company. In particular, the system described in Patent Document 2 aims to increase sales of “a product that a company desires to focus on selling” and gives an incentive to a salesperson who achieves a good sales performance for the product, and the system described in Patent Document 3 aims to increase sales of “a product recommended by a company” and gives an incentive to a salesperson who achieves a good sales performance for the product.

By using the systems described in Patent Documents 1 to 3, it can be expected that the sales of companies will be increased to some extent. However, what companies really desire to do is to increase profits. Increasing profits is realized by increasing sales and reducing costs. However, the systems described in Patent Documents 1 to 3 have a problem that focus is given only to increasing sales by increasing the sales volume of “products that the company desires to focus on selling”, “products recommended by the company”, or the like and increasing profits through cost reduction is not considered.

The invention has been made in order to solve such a problem, and an object thereof is to achieve sales figure increase and cost reduction in a company at the same time by improving product sales performance by increasing the motivation of salespersons, and accordingly, increase profits.

### Solution to Problem

In order to solve the aforementioned problem, for example, in a salesperson evaluation system of the invention, a predetermined index value relevant to sales of each of a plurality of sales target products that are products to be sold by a company is calculated based on sales status data indicating a status of sales of the plurality of sales target products. In addition, it is determined whether or not the calculated index value satisfies predetermined conditions set to indicate that sales are not desirable, and a sales target product satisfying the predetermined conditions is set as a sluggish sales product, and then a point determined by a predetermined rule is given to a salesperson who sells the sluggish sales product.

### Advantageous Effects of the Invention

According to the invention configured as described above, when a salesperson sells a sluggish sales product showing a status in which sales are not desirable among a plurality of sales target products sold by a company, a point is given to the salesperson. This can motivate the salesperson to sell a sluggish sales product, so that it is possible to increase sales figure through an increase in the sales volume of the sluggish sales product. Sluggish sales products may remain unsold if left without taking any measures, and the time during which the sluggish sales products are stored in stock becomes longer. Accordingly, inventory management, return processing, disposal, and the like may increase costs. If such sluggish sales products are sold more by giving motivation to salespersons, it is possible to achieve sales figure increase and cost reduction at the same time. Therefore, according to the invention, it is possible to achieve sales figure increase and cost reduction in a company at the same time by improving product sales performance by increasing the motivation of salespersons, and accordingly, increase profits.

### BRIEF DESCRIPTION OF THE DRAWINGS

FIG. 1 is a diagram illustrating an example of the overall configuration of a salesperson evaluation system according to a first embodiment.

FIG. 2 is a block diagram illustrating a functional configuration example of the salesperson evaluation system according to the first embodiment.

FIG. 3 is a diagram illustrating an example of master data stored in a product master storage unit.

FIG. 4 is a diagram illustrating an example of sales status data stored in a sales status data storage unit.

FIG. 5 is a flowchart illustrating an operation example of the salesperson evaluation system according to the first embodiment.

FIG. 6 is a flowchart illustrating an operation example of the salesperson evaluation system according to the first embodiment.

FIG. 7 is a flowchart illustrating an operation example of the salesperson evaluation system according to the first embodiment.

FIG. 8 is a block diagram illustrating a functional configuration example of a salesperson evaluation system according to a second embodiment.

FIG. 9 is a block diagram illustrating a functional configuration example of a salesperson evaluation system according to another embodiment.

### MODE FOR CARRYING OUT THE INVENTION

### First Embodiment

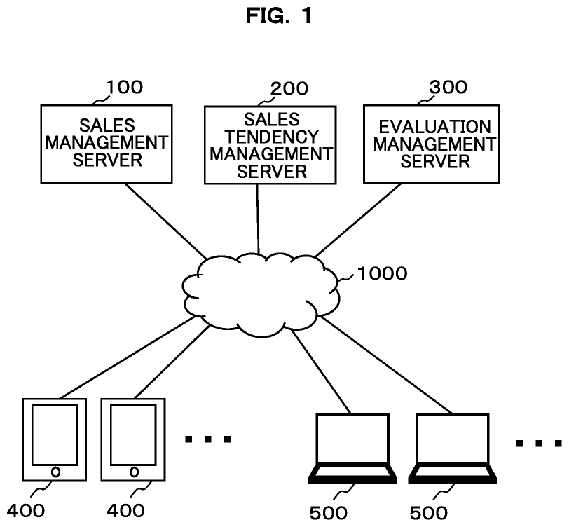

Hereinafter, a first embodiment of the invention will be described with reference to the diagrams. FIG. 1 is a diagram illustrating an example of the overall configuration of a salesperson evaluation system according to the first embodiment. As illustrated in FIG. 1, the salesperson evaluation system according to the first embodiment includes a sales management server 100, a sales tendency management server 200, an evaluation management server 300, a salesperson terminal 400, and a consumer terminal 500. The sales management server 100, the sales tendency management server 200, the evaluation management server 300, the salesperson terminal 400, and the consumer terminal 500 are communicably connected to each other through a communication network 1000, such as the Internet and a mobile phone network.

The sales management server 100 performs sales management of a product to be sold by a company (hereinafter, referred to as a sales target product). The sales management is each process required to post and sell sales target products on the EC site, each process required to take various sales promotion measures for sales target products, and each process required to count the sales status of sales target products sold through the EC site (including consumer reactions to the sales target products posted on the EC site). Details of each of these processes will be sequentially described later.

The sales tendency management server 200 performs a process of monitoring the sales tendency of sales target products posted on the EC site and quantifying the sales tendency. The evaluation management server 300 corresponds to a salesperson evaluation apparatus in the claims, and performs a process of giving a point to a salesperson for evaluation based on the sales tendency of the sales target product quantified by the sales tendency management server 200 and the sales status of the sales target product by the salesperson managed by the sales management server 100. In the present embodiment, a predetermined point is given to a salesperson who sells a sales target product that does not sell well. Details of the processes of the sales tendency management server 200 and the evaluation management server 300 will be described later.

The salesperson terminal 400 is a terminal used by a salesperson in a company that sells a sales target product, and is, for example, a smartphone, a tablet terminal, a personal computer, or the like. The consumer terminal 500 is a terminal used by a consumer who purchases a sales target product, and is, for example, a smartphone, a tablet terminal, a personal computer, or the like. Note that, although FIG. 1 illustrates that the salesperson terminal 400 is a smartphone and the consumer terminal 500 is a personal computer for easy distinction, the invention is not limited thereto.

Note that, although FIG. 1 illustrates an example in which servers are divided into three of the sales management server 100, the sales tendency management server 200, and the evaluation management server 300, the invention is not limited thereto. For example, the sales tendency management server 200 and the evaluation management server 300 may be configured as one server. In addition, the sales management server 100 and the sales tendency management server 200 may be configured as a single server. In addition, all three of the sales management server 100, the sales tendency management server 200, and the evaluation management server 300 may be integrated into one server.

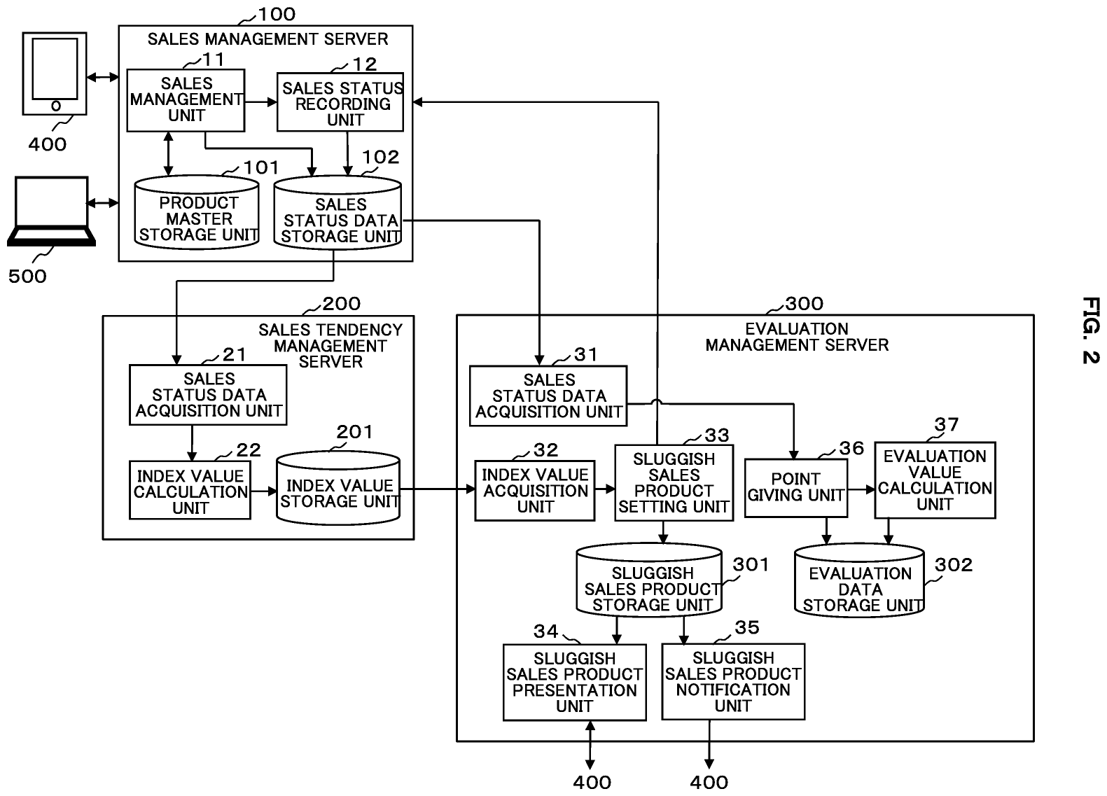

FIG. 2 is a block diagram illustrating the functional configuration of the salesperson evaluation system according to the first embodiment, specifically, a functional configuration example of the sales management server 100, the sales tendency management server 200, and the evaluation management server 300. As illustrated in FIG. 2, the sales management server 100 includes a sales management unit 11 and a sales status recording unit 12 as functional components. In addition, the sales management server 100 includes a product master storage unit 101 and a sales status data storage unit 102 as storage media.

Each of the functional blocks 11 and 12 can be configured by any of hardware, a digital signal processor (DSP), and software. For example, when configured by software, each of the functional blocks 11 and 12 is actually configured to include a CPU, a RAM, and a ROM of a computer, and is realized by the operation of a program stored in a recording medium, such as a RAM, a ROM, a hard disk, or a semiconductor memory.

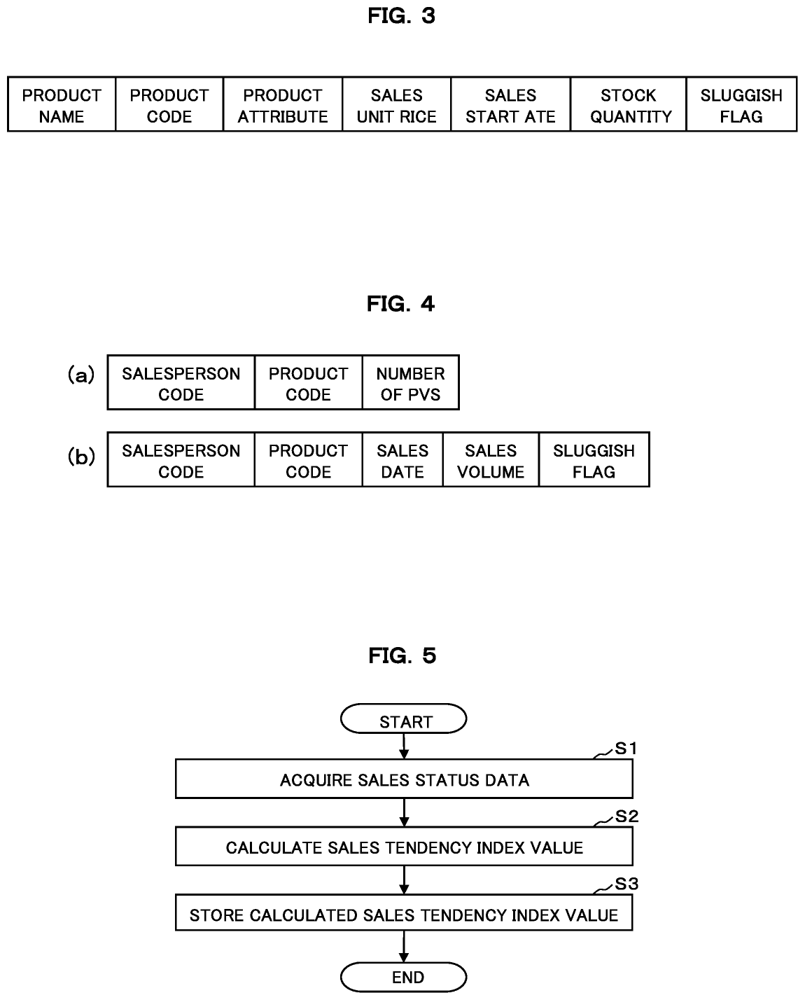

The product master storage unit 101 stores master data regarding a plurality of sales target products. FIG. 3 is a diagram illustrating an example of master data stored in the product master storage unit 101. As illustrated in FIG. 3, the product master storage unit 101 stores data, such as a product name, a product code, product attributes, a sales unit price, a sales start date, a stock quantity, and a sluggish flag, for each of a plurality of sales target products. Note that, the data described herein is merely an example, and the master data may include other pieces of data.

The product attributes are information for specifying different attributes when the same product has different attributes. In the present embodiment, clothes will be described as an example of a sales target product. In this case, the product attributes are the color, size, or the like of the product. The sales start date is the date when the company starts selling the sales target product. The sales start date is used as a starting date when counting the number of days elapsed until the date on which the sales target product is sold. The stock quantity is the number of sales target products purchased by the company as expected to be sold. When the same sales target products are purchased multiple times, the total number of purchases becomes the stock quantity.

The sluggish flag is a flag indicating whether or not the sales target product is set as a sluggish sales product, and any value of active or inactive is stored according to the result of the processing of the evaluation management server 300. In the initial state, a value “0” of inactive indicating that the sales target product is not a sluggish sales product is stored in a sluggish flag. Thereafter, when the sales target product is set as a sluggish sales product by the processing of the evaluation management server 300, the sluggish flag is updated to a value “1” of active indicating that the sales target product is a sluggish sales product. Note that, the sluggish sales product will be described later.

The sales management unit 11 performs various processes required to post and sell the sales target product on the EC site and various processes required to take various sales promotion measures for the sales target product. In the present embodiment, the sales management unit 11 performs processing in which a salesperson operates the salesperson terminal 400 to select an arbitrary sales target product from a plurality of sales target products stored in the product master storage unit 101 and post the selected sales target product on the EC site. The EC site in this case is a personal EC site in which a salesperson selects and posts a sales target product by himself or herself. A support application (hereinafter, referred to as a sales support application) that makes it possible to access the sales management server 100 and perform such processing is installed on the salesperson terminal 400.

Thus, in response to the request from the salesperson terminal 400, the sales management unit 11 performs a process of creating a personal EC site for each of a plurality of salespersons and posting the sales target product selected by each salesperson. The sales management unit 11 stores information regarding which sales target product is posted on which sales person's EC site (in other words, which sales person sells which sales target product), as one of the sales status data, in the sales status data storage unit 102 and manages the information.

Note that, although the example in which an EC site is created for each salesperson has been described herein, the invention is not limited thereto. For example, one EC site may be prepared by a company, and a sales page for each salesperson may be created in the EC site and sales target products selected by each salesperson are posted on the sales page of each salesperson.

In addition, as an example of the processing required for the salesperson to take sales promotion measures for the sales target product, the sales management unit 11 performs a process of posting a coordinate, which is a combination of several sales target products, on the EC site, a process of posting comments on easy-to-understand points or features from the salesperson's point of view on the sales target product on the EC site, and a process of posting the sales target product, comments on the sales target product, and the like on the salesperson's personal SNS (Instagram, Facebook, LINE, and the like all of which are registered trademarks). The coordinate posting function, the comment posting function, and the SNS posting function are also implemented in the sales support application.

In addition, the sales management unit 11 also performs a process relevant to the purchase of a sales target product, which is performed through access to the EC site from the consumer terminal 500. The consumer can browse a plurality of sales target products on a desired EC site and perform a series of procedures for selecting and purchasing a desired sales target product from the plurality of sales target products, and the series of procedures is executed by the sales management unit 11.

The sales status recording unit 12 performs a process of recording the sales status of a sales target product sold through each salesperson's EC site (including consumer reactions to the sales target product posted on the EC site) in the sales status data storage unit 102.

In the present embodiment, as an example, the sales status recording unit 12 counts the number of times (the number of PVs) of opening of the page on which the sales target product is posted, as consumer reactions to the sales target product posted on the EC site, and records the counted number of times in the sales status data storage unit 102 as one of the sales status data. For example, in a case where the EC site is configured to transition to an individual page, on which detailed information of the sales target product or the like is posted, in response to an operation of selecting a certain sales target product by the consumer on a page on which a plurality of sales target products are listed, the sales status recording unit 12 counts the number of times of opening of the individual page for each sales target product and records the counted number of times in the sales status data storage unit 102.

In addition, when consumers purchase sales target products through the EC site, the sales status recording unit 12 acquires information, which indicates when and how many sales target products have been sold from which sales person's EC site, from the sales management unit 11, and records the information in the sales status data storage unit 102 as one of the sales status data.

FIG. 4 is a diagram illustrating an example of sales status data stored in the sales status data storage unit 102. As illustrated in FIG. 4(a), the sales status data storage unit 102 stores a salesperson code, a product code, and the number of PVs, for each of a plurality of salespersons and for each sales target product selected and sold by the salesperson, so as to be associated with each other. The number of PVs is updated (counted up) each time the sales management unit 11 detects that the individual page of the sales target product has been opened.

In addition, as illustrated in FIG. 4(b), the sales status data storage unit 102 stores a salesperson code, a product code, a sales date of a sales target product, a sales volume, and a sluggish flag in one record so as to be associated with each other. For the record in which the data is stored, one record is added each time the sales management unit 11 detects that the sales target product has been purchased by the consumer. For the sluggish flag as sales status data, the value of the sluggish flag which was stored as master data in FIG. 3 when the sales target product was sold is stored.

Note that, FIG. 4 illustrates an example of a method of storing sales status data in the sales status data storage unit 102, and the invention is not limited thereto. In short, data may be stored in such a form that it is possible to grasp the number of PVs of a certain sales target product sold by a certain salesperson, when and how many a certain sales target product sold by a certain salesperson has been sold, and whether or not the sold sales target product is set as a sluggish sales product.

Next, the configuration of the sales tendency management server 200 will be described. As illustrated in FIG. 2, the sales tendency management server 200 includes a sales status data acquisition unit 21 and an index value calculation unit 22 as functional components. In addition, the sales tendency management server 200 includes an index value storage unit 201 as a storage medium.

Each of the functional blocks 21 and 22 can be configured by any of hardware, a DSP, and software. For example, when configured by software, each of the functional blocks 21 and 22 is actually configured to include a CPU, a RAM, and a ROM of a computer, and is realized by the operation of a program stored in a recording medium, such as a RAM, a ROM, a hard disk, or a semiconductor memory.

The sales status data acquisition unit 21 acquires sales status data (sales status data stored in the sales status data storage unit 102), which indicates the sales status of a plurality of sales target products targeted for sale by the company, from the sales management server 100. The sales status data acquisition unit 21 performs the process of acquiring the sales status data from the sales management server 100 periodically, for example, at predetermined time intervals. The predetermined time interval is, for example, every other day or every few days.

For example, the sales status data acquisition unit 21 not only acquires sales status data newly stored in the sales status data storage unit 102 during the latest time interval but also acquires sales status data including sales status data stored in the sales status data storage unit 102 therebefore. Note that, sales status data already acquired by the sales status data acquisition unit 21 may be stored in the sales tendency management server 200, so that the sales status data acquisition unit 21 acquires only the sales status data stored in the sales status data storage unit 102 during the latest time interval and the index value calculation unit 22 uses the past sales status data stored in the sales tendency management server 200 and the latest sales status data newly acquired.

The index value calculation unit 22 performs an index value calculation process described below each time the sales status data acquisition unit 21 acquires the sales status data. As will be described later, the evaluation management server 300 periodically calculates the evaluation value of a salesperson at predetermined time intervals, but it is preferable that the time interval for calculating the index value is the same as or shorter than the time interval for calculating the evaluation value of the salesperson.

The index value calculation unit 22 calculates a predetermined index value (hereinafter, referred to as a sales tendency index value) relevant to the sales tendency of each of a plurality of sales target products based on the sales status data acquired by the sales status data acquisition unit 21. In the present embodiment, the sales tendency index value calculated by the index value calculation unit 22 increases as the sales tendency of the product increase and decreases as the sales tendency of the product decrease. The index value calculation unit 22 updates the sales tendency index value and stores the latest sales tendency index value in the index value storage unit 201 each time the sales tendency index value is calculated at predetermined time intervals.

For example, based on the sales status data acquired by the sales status data acquisition unit 21, the index value calculation unit 22 calculates the sales tendency index value for each sales target product using at least one of the following parameters shown in (1) to (4).

(1) The number of PVs of sales target product: a total of PVs counted for each salesperson as illustrated in FIG. 4 (a)

(2) Sales volume of sales target product: a total of sales volume managed for each record as illustrated in FIG. 4(b)

(3) Sales figure of sales target product: “sales unit price stored as a product master as illustrated in FIG. 3”×“(2) sales volume”

(4) Sales rate or consumption rate of sales target product: “(2) sales volume”÷“stock quantity stored as a product master as illustrated in FIG. 3”

That is, the index value calculation unit 22 calculates the sales tendency index value using a predetermined function using at least one of the above-described (1) to (4) as an explanatory variable and the sales tendency index value as a target variable. (2) to (4) are parameters calculated based on the actual sales performance, and can be said to represent actual sales. On the other hand, (1) is a parameter indicating consumer reactions that may lead to actual sales, and can be said to represent a prospect of future sales. As for the parameter (1), instead of or in addition to this, the number of applauses (likes) given by consumers on the sales target product or the number of bookmarks of a web page on which the sales target product is posted may be used.

The predetermined function used by the index value calculation unit 22 to calculate the sales tendency index value is designed so that the sales tendency index value increases as the value of any of the parameters (1) to (4) increases. In addition, priorities may be set for the parameters (1) to (4), and the function may be designed so that the sales tendency index value increases as the value of the parameter with higher priority increases.

Note that, during a period shortly after the start of sales of the sales target product, the number of PVs or the sales volume of the sales target product is usually not so large. Therefore, if the sales tendency index value is calculated based on the parameters the above-described (1) to (4) during the period shortly after the start of sales, the value is likely to be small. In this case, the calculated sales tendency index value does not necessarily reflect the actual sales tendency of the sales target product. Therefore, the index value calculation unit 22 may calculate the sales tendency index value only for the sales target product for which a predetermined period has passed from the sales start date.

Here, the index value calculation unit 22 may calculate the sales tendency index value by performing weighting according to the sales time based on the sales date (data relevant to the sales time of the sales target product) stored in the sales status data storage unit 102 as illustrated in FIG. 4 (b). For example, a weight value that decreases as the number of days (for example, an average value) elapsed from the sales start date of the sales target product stored as master data as illustrated in FIG. 3 (in the case of calculating the sales tendency index value only for the sales target product for which a predetermined period has passed from the sales start date, the sales tendency index value may be calculated from a date on which the predetermined period has passed) to the sales date stored in the sales status data storage unit 102 increases is set, and the sales tendency index value calculated by a predetermined function using at least one of the above-described (1) to (4) as an explanatory variable is multiplied by the weight value.

For example, for a certain sales target product, if the average value of the number of days elapsed from the sales start date to each sales date is equal to or less than a predetermined number of days, a reference weight value “1.0” is set. After a predetermined number of days, a weight value less than “1.0” is set. The weight value after the predetermined number of days may be set to a value that gradually decreases according to the length of the predetermined number of days. Even in the case of a sales target product that has been actually sold, if the sales target product has been sold over a relatively long period of time from the start of sale, the sale may not be so good. Therefore, for such a sales target product, by adjusting the sales tendency index value by multiplying the sales tendency index value by a weight value less than “1.0”, the accuracy of the sales tendency index value can be further improved.

Note that, the predetermined number of days may be variably set according to the sales target product. That is, depending on the feature of the sales target product, some products may be sold at a stretch shortly after the start of sales, and some products may be sold gradually little by little over a certain period of time. In addition, in the case of seasonal clothes intended to be worn in a certain season, there is a feature that a possibility that a large amount of seasonal clothes will be sold is high before the arrival of the season and during the season, but it is difficult to sell the seasonal clothes after the season. According to such various features of the sales target product, an operation manager (such as a person in charge in a company) of the sales tendency management server 200 may set the predetermined number of days as a variable value. Alternatively, the weight value may be set as a variable value.

Next, the configuration of the evaluation management server 300 will be described. As illustrated in FIG. 2, the evaluation management server 300 includes, as functional components, a sales status data acquisition unit 31, an index value acquisition unit 32, a sluggish sales product setting unit 33, a sluggish sales product presentation unit 34, a sluggish sales product notification unit 35, a point giving unit 36, and an evaluation value calculation unit 37. In addition, the evaluation management server 300 includes a sluggish sales product storage unit 301 and an evaluation data storage unit 302 as storage media.

Each of the functional blocks 31 to 37 can be configured by any of hardware, a DSP, and software. For example, when configured by software, each of the functional blocks 31 to 37 is actually configured to include a CPU, a RAM, and a ROM of a computer, and is realized by the operation of a program stored in a recording medium, such as a RAM, a ROM, a hard disk, or a semiconductor memory. This program corresponds to a salesperson evaluation program described in the claims.

The sales status data acquisition unit 31 acquires sales status data (sales status data stored in the sales status data storage unit 102), which indicates the sales status of a plurality of sales target products targeted for sale by the company, from the sales management server 100. The sales status data acquired by the sales status data acquisition unit 31 is data illustrated in FIG. 4 (b). Note that, instead of or in addition to the salesperson code, a salesperson name may be used. In addition, instead of or in addition to the product code, a product name may be used.

The sales status data acquisition unit 31 performs the process of acquiring the sales status data from the sales management server 100 periodically, for example, at predetermined time intervals. The predetermined time interval is, for example, every other month. Here, the sales status data acquisition unit 31 acquires only the sales status data stored in the sales status data storage unit 102 during the latest time interval (hereinafter, referred to as an evaluation target period).

Each time the sales status data acquisition unit 31 acquires the sales status data, the point giving unit 36 and the evaluation value calculation unit 37 perform a process of giving a point and a process of calculating an evaluation value, which will be described below, based on the sales status data during the evaluation target period. The interval (the length of the evaluation target period) at which a point is given and the evaluation value is calculated may be set in accordance with the timing at which a predetermined incentive (for example, salary, bonus, premium corresponding to the evaluation value, or the like) is given to the salesperson.

The index value acquisition unit 32 acquires an index value relevant to the sales tendency of each of a plurality of sales target products (sales tendency index value for each sales target product stored in the index value storage unit 201), which has been calculated by the sales tendency management server 200 based on the sales status data. The index value acquisition unit 32 performs the process of acquiring the sales tendency index value from the sales tendency management server 200 periodically, for example, at predetermined time intervals. The predetermined time interval is, for example, every other day or every few days.

Each time the index value acquisition unit 32 acquires the sales tendency index value, the sluggish sales product setting unit 33 performs a process of setting a sluggish sales product described below. The interval at which the index value calculation unit 22 calculates the sales tendency index value does not necessarily need to match the interval at which the sluggish sales product setting unit 33 sets a sluggish sales product, but may match.

The sluggish sales product setting unit 33 determines whether or not the sales tendency index value acquired by the index value acquisition unit 32 (sales tendency index value calculated by the index value calculation unit 22) satisfies predetermined conditions set to indicate that sales tendency are not desirable, and sets a sales target product satisfying the predetermined conditions as a sluggish sales product. Then, the sluggish sales product setting unit 33 stores the product code of the sales target product set as a sluggish sales product in the sluggish sales product storage unit 301 so as to be managed.

The predetermined conditions set to indicate that sales tendency are not desirable are, for example, conditions that the sales tendency index value is smaller than those of sales target products whose sales started at the same time. The “sales target products whose sales started at the same time” referred to herein may mean sales target products having the same sales start date stored as master data in the product master storage unit 101, but may mean sales target products whose sales start dates fall within a predetermined width of period. Hereinafter, such sales target products are referred to as “same-time sales start products”.

Specifically, the predetermined conditions can be conditions, such as a sales target product whose deviation value calculated using the sales tendency index values of the same-time sales start products is smaller than a predetermined value, a sales target product whose sales tendency index value is smaller than the average value of the sales tendency index values of the same-time sales start products by a predetermined value or more (the difference from the average value is equal to or greater than a predetermined value), or a predetermined number of sales target products starting from a sales target product with the smallest sales tendency index value among the same-time sales start products. The same-time sales start products whose sales tendency index values are to be used for comparison may be narrowed down to products of the same type (for example, coats as same-time sales start products in the case of a coat or pants as same-time sales start products in the case of pants).

In addition, in the case of calculating the sales tendency index value only for the sales target product for which a predetermined period has passed from the sales start date, the same content as described above may be used as the predetermined conditions, or the conditions that the sales tendency index value is smaller than a predetermined value may be set.

The sluggish sales product setting unit 33 notifies the sales management unit 11 of the sales management server 100 of the product code of the set sluggish sales product. In response to the notification, the sales management unit 11 updates the sluggish flag of the sales target product set as a sluggish sales product (refer to FIG. 3), in the master data stored in the product master storage unit 101, to the value “1” of active indicating a sluggish sales product. After the sluggish flag of the master data is updated to active as described above, when the sales target product (sluggish sales product) is sold, the sales status data is stored in the sales status data storage unit 102 in a state in which the sluggish flag illustrated in FIG. 4 (b) is set to the value “1” of active.

The sluggish sales product presentation unit 34 and the sluggish sales product notification unit 35 correspond to a sluggish sales product informing unit in the claims. The sluggish sales product presentation unit 34 presents one or more sluggish sales products set by the sluggish sales product setting unit 33 to the salesperson through a display on the salesperson terminal 400. For example, in response to a request from a web browser provided in the salesperson terminal 400, the sluggish sales product presentation unit 34 creates a web page on which sluggish sales products are listed with reference to the sluggish sales product storage unit 301, and causes the web browser to display the web page. This web browser may be a browser function included in the sales support application.

The sluggish sales product notification unit 35 notifies the salesperson of one or more sluggish sales products set by the sluggish sales product setting unit 33 through the salesperson terminal 400. For example, the sluggish sales product notification unit 35 notifies the salesperson of a sluggish sales product by push notification or e-mail to the sales support application. Specifically, each time a sluggish sales product is newly set by the sluggish sales product setting unit 33, the salesperson terminal 400 is notified of the sluggish sales product by push notification.

By the presentation of a sluggish sales product by the sluggish sales product presentation unit 34 or the notification of a sluggish sales product by the sluggish sales product notification unit 35, the salesperson can grasp which of the sales target products is set as a sluggish sales product. In the present embodiment, a predetermined point is given to a salesperson when a sales target product that does not sell well, that is, a sluggish sales product is sold. Therefore, the salesperson can grasp which product is a sluggish sales product and post the sluggish sales product on the personal EC site for sale. In addition, the salesperson can take sales promotion measures to actively sell the sluggish sales product using the coordinate posting function, the comment posting function, the SNS posting function, and the like of the sales support application.

Note that, although the configuration including both the sluggish sales product presentation unit 34 and the sluggish sales product notification unit 35 is illustrated herein, a configuration including only one of the sluggish sales product presentation unit 34 and the sluggish sales product notification unit 35 may be used. In addition, when a salesperson selects an arbitrary sales target product from the product master and designates posting the selected sales target product on the personal EC site, a selection screen configured such that whether or not the sales target product is set as a sluggish sales product can be identified based on the sluggish flag stored as the master data as illustrated in FIG. 3 may be presented. The function of presenting such a selection screen also corresponds to the sluggish sales product informing unit in the claims.

Based on the sales status data acquired by the sales status data acquisition unit 31, the point giving unit 36 gives a point determined by a predetermined rule to the salesperson who sells the sluggish sales product (sales target product for which the sluggish flag illustrated in FIG. 4 (b) indicates the value “1” of active) set by the sluggish sales product setting unit 33. For example, the point giving unit 36 gives a predetermined point to the salesperson each time one sluggish sales product is sold. Then, the point giving unit 36 stores the given point in the evaluation data storage unit 302 so as to be managed for each salesperson.

Here, the point is a numerical value used when the evaluation value calculation unit 37 calculates the evaluation value of each salesperson, and may be called a score. The predetermined rule is, for example, a rule in which a point as a fixed value is given for sales of a sluggish sales product and no points are given for other sales target products. Note that, the rule may be set such that a point to be given when selling a sluggish sales product becomes a different value according to the magnitude of the sales tendency index value calculated by the index value calculation unit 33. For example, a larger point is given as the sales tendency index value becomes smaller.

The evaluation value calculation unit 37 calculates, for each salesperson, sales points by adding up the points given by the point giving unit 36 for respective sales target products sold per unit period, and calculates an evaluation value relevant to the sales performance of the salesperson per unit period using the sales points. Then, the evaluation value calculation unit 37 stores the calculated evaluation value in the evaluation data storage unit 302 so as to be managed for each salesperson. Here, the unit period is an evaluation target period (for example, one month) as a predetermined time interval in which the point giving unit 36 and the evaluation value calculation unit 37 perform processes. In addition, the point given by the point giving unit 36 is a point given by selling a sluggish sales product. In the present embodiment, “evaluation value relevant to sales performance of salesperson” per unit period=“sales point” or “value corresponding to sales point”.

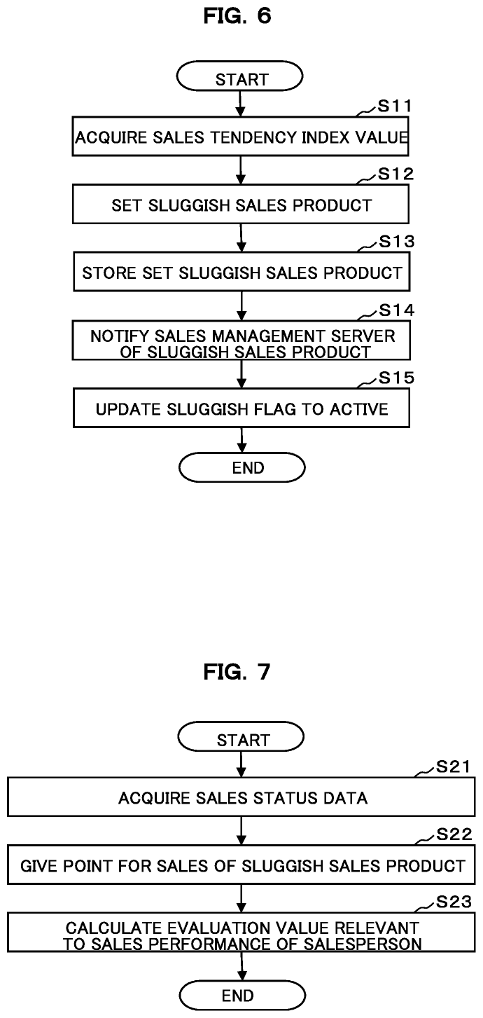

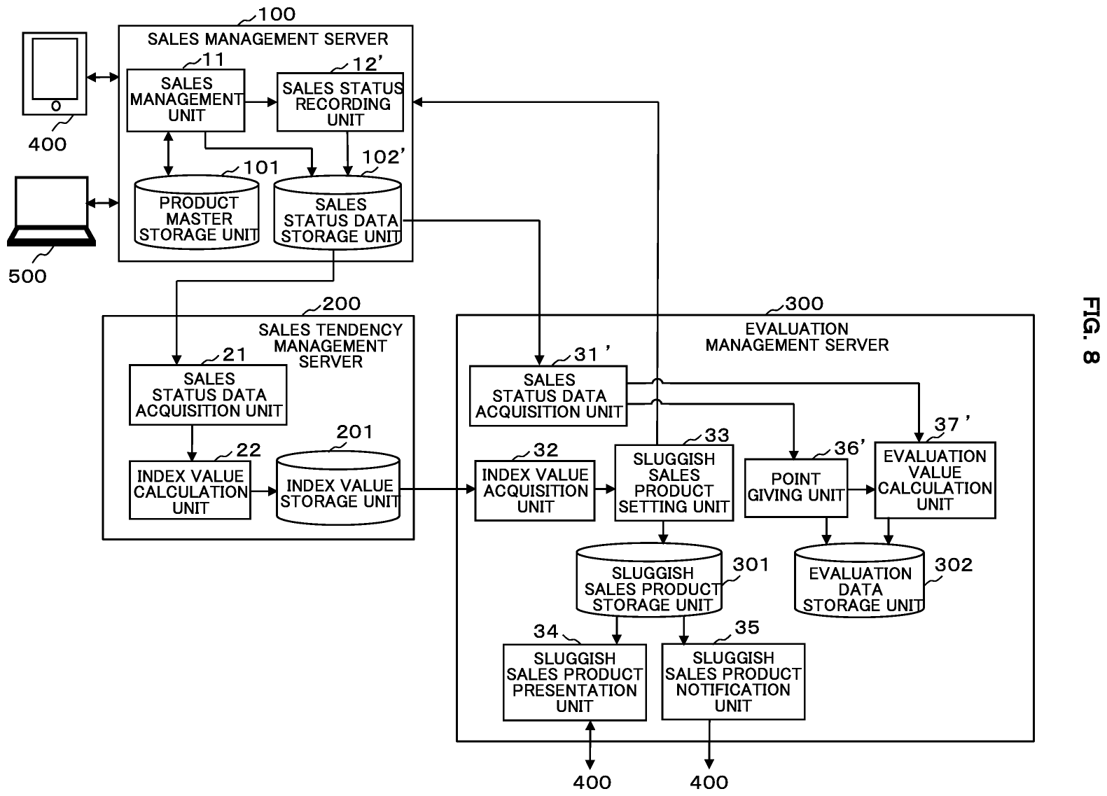

FIGS. 5 to 7 are flowcharts illustrating an operation example of the salesperson evaluation system according to the first embodiment configured as described above. FIG. 5 illustrates an operation example of calculating a sales tendency index value in the sales tendency management server 200. FIG. 6 illustrates an operation example in which the evaluation management server 300 sets a sluggish sales product and updates the sluggish flag in the master data of the sales management server 100. FIG. 7 illustrates an operation example of calculating an evaluation value in the evaluation management server 300.

The operation of the sales tendency management server 200 illustrated in FIG. 5 is repeatedly performed at predetermined time intervals (for example, every other day). First, the sales status data acquisition unit 21 acquires sales status data of a plurality of sales target products from the sales management server 100 (step S1). Then, the index value calculation unit 22 calculates a sales tendency index value for each of the plurality of sales target products based on the sales status data acquired by the sales status data acquisition unit 21 (step S2), and updates and stores the calculated sales tendency index value in the index value storage unit 201 (step S3).

The operations of the evaluation management server 300 and the sales management server 100 illustrated in FIG. 6 are repeatedly performed at predetermined time intervals (for example, every other day). First, the index value acquisition unit 32 acquires the sales tendency index value for each sales target product calculated by the sales tendency management server 200 (step S11). Then, the sluggish sales product setting unit 33 determines whether or not the sales tendency index value for each of sales target product acquired by the index value acquisition unit 32 satisfies predetermined conditions set to indicate that sales tendency are not desirable, and sets a sales target product satisfying the predetermined conditions as a sluggish sales product (step S12).

Then, the sluggish sales product setting unit 33 stores the product code of the set sluggish sales product in the sluggish sales product storage unit 301 (step S13). In addition, the sluggish sales product setting unit 33 notifies the sales management unit 11 of the sales management server 100 of the product code of the set sluggish sales product (step S14). In response to the notification, the sales management unit 11 updates the sluggish flag of the sales target product set as a sluggish sales product, in the master data stored in the product master storage unit 101, to the value “1” of active indicating a sluggish sales product (step S15).

The operation of the evaluation management server 300 illustrated in FIG. 7 is repeatedly performed at predetermined time intervals (for example, every other month). First, the sales status data acquisition unit 31 acquires sales status data (data illustrated in FIG. 4(b)) of a plurality of sales target products from the sales management server 100 (step S21). Then, the point giving unit 36 gives a point to the salesperson who sells the sluggish sales product set by the sluggish sales product setting unit 33 based on the sales status data acquired by the sales status data acquisition unit 31, and stores the point in the evaluation data storage unit 302 (step S22).

In addition, the evaluation value calculation unit 37 calculates, for each salesperson, sales points by adding up the points given by the point giving unit 36 for respective sales target products sold per unit period. Then, an evaluation value relevant to the sales performance of the salesperson per unit period is calculated using the sales points, and the calculated evaluation value is stored in the evaluation data storage unit 302 (step S23).

As described above in detail, in the first embodiment, a predetermined sales tendency index value relevant to the sales tendency of each of a plurality of sales target products is calculated based on the sales status data indicating the sales status of the plurality of sales target products. In addition, it is determined whether or not the calculated sales tendency index value satisfies predetermined conditions set to indicate that sales tendency are not desirable, and a sales target product satisfying the predetermined conditions is set as a sluggish sales product. Then, a point determined by a predetermined rule is given to the salesperson who sells the sluggish sales product.

According to the first embodiment configured as described above, when a salesperson sells a sluggish sales product showing a status in which sales tendency are not desirable among a plurality of sales target products sold by a company, a point is given to the salesperson. This can motivate the salesperson to sell a sluggish sales product, so that it is possible to increase sales figure through an increase in the sales volume of the sluggish sales product.

Sluggish sales products may remain unsold if left without taking any measures, and the time during which the sluggish sales products are stored in stock becomes longer. Accordingly, inventory management, return processing, disposal, and the like may increase costs. If such sluggish sales products are sold more by giving motivation to salespersons, it is possible to achieve sales figure increase and cost reduction at the same time. Therefore, according to the first embodiment, it is possible to achieve sales figure increase and cost reduction in a company at the same time by improving product sales performance by increasing the motivation of salespersons, and accordingly, increase profits.

### Second Embodiment

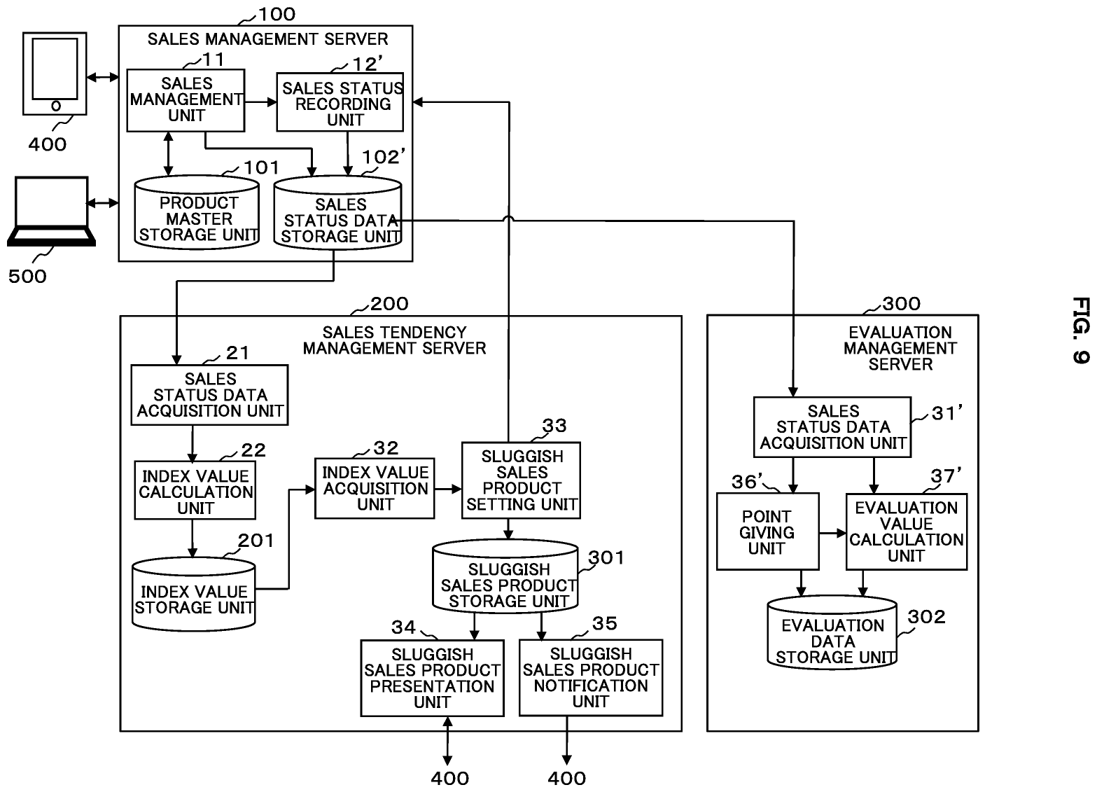

Next, a second embodiment of the invention will be described with reference to the diagrams. FIG. 8 is a block diagram illustrating an example of the functional configuration of the sales management server 100, the sales tendency management server 200, and the evaluation management server 300 according to the second embodiment. Note that, in FIG. 8, components denoted by the same reference numerals as those illustrated in FIG. 2 have the same functions, and accordingly, repeated description thereof will be omitted herein.

As illustrated in FIG. 8, the sales management server 100 according to the second embodiment includes a sales status recording unit 12′ and a sales status data storage unit 102′ instead of the sales status recording unit 12 and the sales status data storage unit 102. In addition, the evaluation management server 300 according to the second embodiment includes a sales status data acquisition unit 31′, a point giving unit 36′, and an evaluation value calculation unit 37′ instead of the sales status data acquisition unit 31, the point giving unit 36, and the evaluation value calculation unit 37.

The sales status recording unit 12′ of the sales management server 100 records, as sales status data, data regarding the implementation status of sales promotion measures taken by the salesperson, data regarding consumer reactions to the sales promotion measures, and data regarding the sales performance for the sales target product in the sales status data storage unit 102′. These pieces of data are stored separately from the sales status data illustrated in FIG. 4, for example.

The data regarding the implementation status of sales promotion measures taken by the salesperson (hereinafter, referred to as sales promotion implementation status data) is data indicating the implementation status of sales promotion measures taken by the salesperson using the coordinate posting function, the comment posting function, and the SNS posting function of the sales support application. Specifically, the sales promotion implementation status data includes a posting site code indicating the EC site where the salesperson posted the sales target product, information indicating the sales target product to be posted (product code or product name), a salesperson code, and the like.

The data regarding consumer reactions to the sales promotion measures (hereinafter, referred to as sales promotion reaction data) includes information, such as a posting site code indicating the EC site where the salesperson posted the sales target product, a product code of the sales target product posted by the salesperson, a salesperson code, the number of PVs, and the like.

In addition, the data regarding the sales performance for the sales target product (hereinafter, referred to as sales promotion product sales performance data) includes information, such as a product code of the sold sales target product, a salesperson code, a sales date, and a sales volume and a posting site code indicating an inflow source that indicates through which EC site (posting site) the sales target product has been sold.

The sales status data acquisition unit 31′ acquires the sales promotion implementation status data, the sales promotion reaction status data, and the sales promotion product sales performance data stored in the sales status data storage unit 102′ by the sales status recording unit 12′, in addition to the sales status data described in the first embodiment. The sales status data acquisition unit 31′ provides the sales status data described in the first embodiment to the point giving unit 36′. In addition, the sales status data acquisition unit 31′ provides the sales promotion implementation status data, the sales promotion reaction status data, and the sales promotion product sales performance data described in the second embodiment to the evaluation value calculation unit 37′.

The point giving unit 36′ gives a point, which is determined by a predetermined rule for each of sold sales target products, to a salesperson who sells a plurality of sales target products. In the second embodiment, in addition to giving a point to a salesperson who sells a sluggish sales product, a point is also given when a normal sales target product that is not a sluggish sales product is sold. Here, the point given when a sluggish sales product set by the sluggish sales product setting unit 33 is sold is set to be larger than the point given when a normal sales target product that is not a sluggish sales product is sold.

In this manner, by giving a point corresponding to the sales performance to each salesperson for all sales target products, it is possible to give the salesperson motivation to increase the sales performance for all the sales target products. In addition, by giving a larger point as the sales performance for a sluggish sales product increases, it is possible to give the salesperson motivation to increase the sales performance particularly for the sluggish sales product.

Here, the point giving unit 36′ may set a point given when a normal sales target product is sold to a fixed value, and may give a point given when a sluggish sales product is sold, as a different value, according to the magnitude of the sales tendency index value calculated by the index value calculation unit 33 for the sluggish sales product. For example, a larger point is given as the sales tendency index value becomes smaller.

The evaluation value calculation unit 37′ calculates a status point from at least one of the implementation status of sales promotion measures, the consumer reaction status, and the sales performance for the sales target product based on at least one of the sales promotion implementation status data, the sales promotion reaction status data, and the sales promotion product sales performance data acquired by the sales status data acquisition unit 31′. Then, the evaluation value calculation unit 37′ calculates an evaluation value relevant to the sales performance of each salesperson per unit period using a sales point calculated by adding up the points given by the point giving unit 36′ (described in the first embodiment) and the status point.

Here, the evaluation value calculation unit 37′ calculates the status point using at least one of the following parameters (A) to (G), for example.

(A) Salesperson's sales figure: total sales figure of all sales target products sold by a salesperson during a unit period

(B) The number of posted contents: the total number of contents posted by coordinate posting, comment posting, and SNS posting. The content means a coordinate when a combination of a plurality of sales target products is posted as a coordinate, and means one sales target product when the one sales target product is posted.

(C) Average sales figure of one content: average sales figure of each piece of posted content

(D) The number of PVs: the total number of PVs of all contents posted by a salesperson during a unit period

(E) The number of customers attracted by SNS: the number of customers attracted by the salesperson's personal SNS among all customers for a sales target product sold by a salesperson during a unit period

(F) Sales figure through SNS: Total sales figure of sales target products sold to customers attracted by the salesperson's personal SNS among sales target products sold by a salesperson during a unit period

(G) Sales figure through posting to other EC sites: Total sales figure of sales target products sold to customers attracted by EC sites on which the sales target products are posted by coordinate posting and comment posting

That is, the evaluation value calculation unit 37′ calculates a status point using a predetermined function using at least one of the above-described (A) to (G) as an explanatory variable and the status point as a target variable. The predetermined function used by the evaluation value calculation unit 37′ to calculate the status point is designed so that the status point increases as the value of any of the parameters (A) to (G) increases. In addition, priorities may be set for the parameters (A) to (G), and the function may be designed so that the status point increases as the value of the parameter with higher priority increases.

As described above, the evaluation value calculation unit 37′ calculates an evaluation value relevant to the sales performance of a salesperson per unit period using the status point calculated as described above and the sales point calculated by adding up the points given by the point giving unit 36′. For example, the evaluation value of the salesperson is calculated by adding up the sales point and the status point or multiplying the sales point and the status point together. In this manner, it is possible to reflect the number of PVs or the sales performance of sluggish sales products, as a sales point, in the evaluation value while reflecting the implementation status of sales promotion measures by the salesperson or the sales performance for all sales target products, as a status point, in the evaluation value.

Note that, since the implementation status or the sales performance of sales promotion measures by the salesperson for a normal sales target product other than the sluggish sales product is reflected in the evaluation value as a status point, the sales point according to the first embodiment in which a point is given only when the sluggish sales product is sold may be used as a sales point (that is, the point giving unit 36 may be used instead of the point giving unit 36′).

When calculating the evaluation value of the salesperson from the sales point and the status point, the evaluation value calculation unit 37′ may calculate the evaluation value based on a function in which the percentage of the sales point reflected in the evaluation value is equal to or greater than the percentage of the status point reflected in the evaluation value. In this manner, it is possible to calculate the evaluation value of each salesperson in a state in which the number of PVs or the sales performance of the sluggish sales product is more strongly reflected while reflecting the implementation status of sales promotion measures by the salesperson or the sales performance for all sales target products. As a result, it is possible to give strong motivation for selling the sluggish sales product to the salesperson.

Note that, in the second embodiment, the sales status recording unit 12′, the sales status data storage unit 102′, and the evaluation value calculation unit 37′ may be replaced with the sales status recording unit 12, the sales status data storage unit 102, and the evaluation value calculation unit 37 as in the first embodiment, and the content of the second embodiment may be applied only to the point giving unit 36′.

In addition, in the second embodiment, as illustrated in FIG. 9, the index value acquisition unit 32, the sluggish sales product setting unit 33, the sluggish sales product presentation unit 34, the sluggish sales product notification unit 35, and the sluggish sales product storage unit 301 may be provided in the sales tendency management server 200. The same applies to the first embodiment.

In addition, in the first and second embodiments, an example has been described in which a salesperson selects a sales target product by himself or herself from the product master to create a personal EC site. However, the invention is not limited thereto. For example, there may be a configuration in which there is one EC site on which all sales target products are posted and a salesperson creates a sales promotion site separately from the EC site and links the sales promotion site to the EC site.

In addition, in the first and second embodiments, as an example of a case where the index value calculation unit 22 calculates the sales tendency index value by performing weighting according to the sales time of the sales target product, the content of calculating the sales tendency index value by performing multiplication using the weight value set according to the number of days elapsed from the sale start date to the sale date of the sales target product has been described. However, the invention is not limited thereto. For example, in the case of campaign sales, the weight value may be changed before, during, or after the campaign period.

In addition, in the first and second embodiments, an example has been described in which the index value calculation unit 22 calculates the sales tendency index value using the sales status data of the entire period stored in the sales status data storage unit 102. However, the invention is not limited thereto. For example, the index value calculation unit 22 may calculate the sales tendency index value at predetermined time intervals only for the sales status data newly stored in the sales status data storage unit 102 during the latest time interval.

In addition, in the first and second embodiments, an example has been described in which the evaluation value calculation unit 37 calculates the evaluation value per unit period each time the evaluation target period passes. However, the invention is not limited thereto. For example, each time the evaluation target period passes, the evaluation value of the salesperson for the entire period may be calculated using the sales status data of the entire period stored in the sales status data storage unit 102. Alternatively each time the evaluation target period passes, the latest evaluation value may be calculated only for the sales status data newly stored in the sales status data storage unit 102 during the latest time interval, and this may be accumulated in the past evaluation value.

In addition, in the first and second embodiments, an example has been described in which the points given by the point giving units 36 and 36′ are simple numerical values that are used when the evaluation value calculation units 37 and 37′ calculate the evaluation value of the salesperson. However, the invention is not limited thereto. For example, the evaluation value calculation units 37 and 37′ may be eliminated, and the points given by the point giving units 36 and 36′ may be points having economic value that can be used in actual commercial transactions.

In addition, in the first and second embodiments, a case where the sales target product is clothes has been described as an example. However, the sales target product is not limited to clothes. All products can be sales targets. In addition, products to be handled may be either products as goods or products as a service.

In addition, in the first and second embodiments, a case where products are sold at the EC site has been described as an example. However, the invention can also be applied to a case where products are sold at an actual store. For example, it is possible to acquire data regarding the sales performance for a product and a salesperson in charge from a point of sale (POS) system, which is used when selling the product at an actual store, and execute the same processing as the processing described in the first and second embodiments using the data acquired from the POS system. Here, the data indicating the salesperson in charge may be specified, for example, by reading a two-dimensional code.

In addition, each of the first and second embodiments is merely an example of implementation in carrying out the invention, and these should not be interpreted as limiting the technical scope of the invention. That is, the invention can be implemented in various forms without departing from the gist or main features thereof.

### REFERENCE SIGNS LIST

11 Sales management unit
12, 12′ Sales status recording unit
21 Sales status data acquisition unit
22 Index value calculation unit
31, 31′ Sales status data acquisition unit
32 Index value acquisition unit
33 Sluggish sales product setting unit
34 Sluggish sales product presentation unit (sluggish sales product informing unit)
35 Sluggish sales product notification unit (sluggish sales product informing unit)
36, 36′ Point giving unit
37, 37′ Evaluation value calculation unit
100 Sales management server
200 Sales tendency management server
300 Evaluation management server (salesperson evaluation apparatus)
400 Salesperson terminal
500 Consumer terminal

1. A salesperson evaluation system, comprising:
a sales status data acquisition unit that acquires sales status data indicating a status of sales of a plurality of sales target products that are products to be sold by a company;
an index value calculation unit that calculates a predetermined index value relevant to sales tendency of each of the plurality of sales target products based on the sales status data acquired by the sales status data acquisition unit;
a sluggish sales product setting unit that determines whether or not the index value calculated by the index value calculation unit satisfies predetermined conditions set to indicate that sales tendency are not desirable and sets a sales target product satisfying the predetermined conditions as a sluggish sales product; and
a point giving unit that gives a point determined by a predetermined rule to a salesperson, who sells the sluggish sales product set by the sluggish sales product setting unit, based on the sales status data acquired by the sales status data acquisition unit, the sales status data includes a salesperson, the sales target product sold by the salesperson and an information indicating whether or not the sales target product is a sluggish sales product;
wherein the sales status data includes data regarding a time when the sales target product is sold, and
the index value calculation unit calculates the predetermined index value by performing weighting according to a sales time.

2. The salesperson evaluation system according to claim 1, further comprising:
a sluggish sales product informing unit that informs the salesperson of the sluggish sales product set by the sluggish sales product setting unit.

3. The salesperson evaluation system according to claim 1,
wherein the point giving unit gives a point, which is determined by the predetermined rule for each of sales target products that are sold, to a salesperson who sells the plurality of sales target products, and sets a point given when the sluggish sales product set by the sluggish sales product setting unit is sold to be larger than a point given when a sales target product that is not the sluggish sales product is sold.

4. The salesperson evaluation system according to claim 1,
wherein the point giving unit gives a point as a different value according to a magnitude of the index value calculated by the index value calculation unit for the sluggish sales product.

5. The salesperson evaluation system according to claim 1, further comprising:
an evaluation value calculation unit that calculates a sales point for each salesperson by adding up points given by the point giving unit for respective sales target products that are sold and calculates an evaluation value relevant to sales performance of the salesperson using the sales point.

6. The salesperson evaluation system, comprising:
a sales status data acquisition unit that acquires sales status data indicating a status of sales of a plurality of sales target products that are products to be sold by a company, the sales status data includes data regarding an implementation status of sales promotion measures taken by a salesperson, data regarding consumer reaction status to the sales promotion measures, data regarding sales performance for the sales target products taken the sales promotion measures and a performance data, the performance data includes the salesperson, the sales target product sold by the salesperson and an information indicating whether or not the sales target product is a sluggish sales product;
an index value calculation unit that calculates a predetermined index value relevant to sales tendency of each of the plurality of sales target products based on the performance data acquired by the sales status data acquisition unit;
a sluggish sales product setting unit that determines whether or not the index value calculated by the index value calculation unit satisfies predetermined conditions set to indicate that sales tendency are not desirable and sets a sales target product satisfying the predetermined conditions as the sluggish sales product;
a point giving unit that gives a point determined by a predetermined rule to a salesperson, who sells the sluggish sales product set by the sluggish sales product setting unit, based on the performance data acquired by the sales status data acquisition unit; and
an evaluation value calculation unit that calculates a sales point for each salesperson by adding up points given by the point giving unit for respective sales target products that are sold, calculates a status point from at least one of the implementation status of the sales promotion measures, the consumer reaction status, and the sales performance for the sales target products taken the sales promotion measures, and calculates an evaluation value relevant to sales performance of the salesperson using the sales point and the status point.

7. The salesperson evaluation system according to claim 6,
wherein the evaluation value calculation unit calculates the evaluation value based on a function in which a percentage of the sales point reflected in the evaluation value is equal to or greater than a percentage of the status point reflected in the evaluation value.

8. A salesperson evaluation apparatus used in the salesperson evaluation system according to claim 5, comprising:
the sluggish sales product setting unit, the point giving unit and the index value calculation unit.

9. A salesperson evaluation apparatus used in the salesperson evaluation system according to claim 5, comprising:
the point giving unit and the index value calculation unit.

10. A salesperson evaluation apparatus, comprising:
an index value acquisition unit that acquires a predetermined index value relevant to sales tendency of each of a plurality of sales target products that are products to be sold by a company, the predetermined index value being calculated based on sales status data indicating a status of sales of the plurality of sales target products;
a sluggish sales product setting unit that determines whether or not the index value acquired by the index value acquisition unit satisfies predetermined conditions set to indicate that sales tendency are not desirable and sets a sales target product satisfying the predetermined conditions as a sluggish sales product;
a point giving unit that gives a point determined by a predetermined rule to a salesperson, who sells the sluggish sales product set by the sluggish sales product setting unit, based on the sales status data, the sales status data includes a salesperson, the sales target product sold by the salesperson and an information indicating whether or not the sales target product is a sluggish sales product; and
an evaluation value calculation unit that calculates a sales point for each salesperson by adding up points given by the point giving unit for respective sales target products that are sold, calculates a status point from at least one of the implementation status of the sales promotion measures, the consumer reaction status, and the sales performance for the sales target products taken the sales promotion measures based on the data regarding an implementation status of sales promotion measures taken by a salesperson, data regarding consumer reaction status to the sales promotion measures, and data regarding sales performance for the sales target products taken the sales promotion measures, and calculates an evaluation value relevant to sales performance of the salesperson using the sales point and the status point.

11. A salesperson evaluation method, comprising:
a first step in which an index value acquisition unit of a computer acquires a predetermined index value relevant to sales tendency of each of a plurality of sales target products that are products to be sold by a company, the predetermined index value being calculated based on sales status data indicating a status of sales of the plurality of sales target products;
a second step in which a sluggish sales product setting unit of the computer determines whether or not the index value acquired by the index value acquisition unit satisfies predetermined conditions set to indicate that sales tendency are not desirable and sets a sales target product satisfying the predetermined conditions as a sluggish sales product;
a third step in which a point giving unit of the computer gives a point determined by a predetermined rule to a salesperson, who sells the sluggish sales product set by the sluggish sales product setting unit, based on the sales status data asynchronously with the first and second steps, the sales status data includes a salesperson, the sales target product sold by the salesperson and an information indicating whether or not the sales target product is a sluggish sales product; and
a fourth step in which an evaluation value calculation unit of the computer calculates a sales point for each salesperson by adding up points given by the point giving unit for respective sales target products that are sold, calculates a status point from at least one of the implementation status of the sales promotion measures, the consumer reaction status, and the sales performance for the sales target products taken the sales promotion measures based on the data regarding an implementation status of sales promotion measures taken by a salesperson, data regarding consumer reaction status to the sales promotion measures, and data regarding sales performance for the sales target products taken the sales promotion measures, and calculates an evaluation value relevant to sales performance of the salesperson using the sales point and the status point.

12. A salesperson evaluation program causing a computer to function as:
a sales status data acquisition means that acquires sales status data indicating a status of sales of a plurality of sales target products that are products to be sold by a company, the sales status data includes data regarding a time when the sales target product is sold;
an index value calculation means that calculates a predetermined index value relevant to sales tendency of each of the plurality of sales target products by performing weighting according to a sales time based on the sales status data acquired by the sales status data acquisition means;
a sluggish sales product setting means that determines whether or not the index value calculated by the index value calculation means satisfies predetermined conditions set to indicate that sales tendency are not desirable and sets a sales target product satisfying the predetermined conditions as a sluggish sales product; and
a point giving means that gives a point determined by a predetermined rule to a salesperson, who sells the sluggish sales product set by the sluggish sales product setting means, based on the sales status data acquired by the sales status data acquisition means, the sales status data includes a salesperson, the sales target product sold by the salesperson and an information indicating whether or not the sales target product is a sluggish sales product.

13. A salesperson evaluation program causing a computer to function as:
a sales status data acquisition means that acquires sales status data indicating a status of sales of a plurality of sales target products that are products to be sold by a company, the sales status data includes data regarding an implementation status of sales promotion measures taken by a salesperson, data regarding consumer reaction status to the sales promotion measures, data regarding sales performance for the sales target products taken the sales promotion measures and a performance data, the performance data includes the salesperson, the sales target product sold by the salesperson and an information indicating whether or not the sales target product is a sluggish sales product;
an index value calculation means that calculates a predetermined index value relevant to sales tendency of each of the plurality of sales target products based on the performance data acquired by the sales status data acquisition means;
a sluggish sales product setting means that determines whether or not the index value calculated by the index value calculation means satisfies predetermined conditions set to indicate that sales tendency are not desirable and sets a sales target product satisfying the predetermined conditions as the sluggish sales product;
a point giving means that gives a point determined by a predetermined rule to a salesperson, who sells the sluggish sales product set by the sluggish sales product setting means, based on the performance data acquired by the sales status data acquisition means; and
an evaluation value calculation means that calculates a sales point for each salesperson by adding up points given by the point giving means for respective sales target products that are sold, calculates a status point from at least one of the implementation status of the sales promotion measures, the consumer reaction status, and the sales performance for the sales target products taken the sales promotion measures, and calculates an evaluation value relevant to sales performance of the salesperson using the sales point and the status point.

14. A salesperson evaluation program causing a computer to function as:
index value acquisition means for acquiring a predetermined index value relevant to sales tendency of each of a plurality of sales target products that are products to be sold by a company, the predetermined index value being calculated based on sales status data indicating a status of sales of the plurality of sales target products;
sluggish sales product setting means for determining whether or not the index value acquired by the index value acquisition means satisfies predetermined conditions set to indicate that sales tendency are not desirable and setting a sales target product satisfying the predetermined conditions as a sluggish sales product; and
point giving means for giving a point determined by a predetermined rule to a salesperson, who sells the sluggish sales product set by the sluggish sales product setting means, based on the sales status data, the sales status data includes a salesperson, the sales target product sold by the salesperson and an information indicating whether or not the sales target product is a sluggish sales product; and
an evaluation value calculation means that calculates a sales point for each salesperson by adding up points given by the point giving means for respective sales target products that are sold, calculates a status point from at least one of the implementation status of the sales promotion measures, the consumer reaction status, and the sales performance for the sales target products taken the sales promotion measures based on the data regarding an implementation status of sales promotion measures taken by a salesperson, data regarding consumer reaction status to the sales promotion measures, and data regarding sales performance for the sales target products taken the sales promotion measures, and calculates an evaluation value relevant to sales performance of the salesperson using the sales point and the status point.

15. A salesperson evaluation program causing a computer to function as:
point giving means for giving a point determined by a predetermined rule to a salesperson, who sells a sluggish sales product, based on sales status data indicating a status of sales of a plurality of sales target products that are products to be sold by a company, the sales status data includes a salesperson, the sales target product sold by the salesperson and data indicating that the sales target product for which a predetermined index value relevant to sales tendency of the sales target product satisfies predetermined conditions is a sluggish sales product; and
an evaluation value calculation means that calculates a sales point for each salesperson by adding up points given by the point giving means for respective sales target products that are sold, calculates a status point from at least one of the implementation status of the sales promotion measures, the consumer reaction status, and the sales performance for the sales target products taken the sales promotion measures based on the data regarding an implementation status of sales promotion measures taken by a salesperson, data regarding consumer reaction status to the sales promotion measures, and data regarding sales performance for the sales target products taken the sales promotion measures, and calculates an evaluation value relevant to sales performance of the salesperson using the sales point and the status point.

16. A salesperson evaluation apparatus used in the salesperson evaluation system according to claim 6, comprising:
the sluggish sales product setting unit, the point giving unit and the index value calculation unit.

17. A salesperson evaluation apparatus used in the salesperson evaluation system according to claim 6, comprising:
the point giving unit and the index value calculation unit.
